(19) United States
(12) Patent Application Publication
(10) Pub. No.: US 2016/0195855 A1
(43) Pub. Date: Jul. 7, 2016

(54) APPARATUS FOR DISPLAYING INFORMATION

(71) Applicant: llyas Mirza, Ontario (CA)

(72) Inventor: llyas Mirza, Ontario (CA)

(21) Appl. No.: 14/989,352

(22) Filed: Jan. 6, 2016

Related U.S. Application Data
(60) Provisional application No. 62/100,239, filed on Jan. 6, 2015.

(51) Int. Cl. G04G 17/08; G04G 13/02; G04G 9/00; A47G 1/06; G04G 21/08

(52) U.S. Cl. CPC G04G 17/08; A47G 1/0622; G04G 21/08; G04G 9/00; G04G 13/02

(57) ABSTRACT

An apparatus for use with a picture therein having a subassembly, a computing functionality, sixty lights, and touch-sensitive buttons for receipt of an input. The subsassembly includes a body having a mount for releasably supporting the picture, and the sixty lights are arranged to surround the mount in a sequential order. Each of the lights, touch-sensitive buttons, and computing functionality are directly or indirectly electrically coupled to each other. The computing functionality is adapted to direct operation of the lights in accordance with a mode of light operation selected in dependence on the input received from the touch-sensitive buttons, one of which is a single light mode in which each of the sixty lights is sequentially actuated for a period of one second so that the position of the actuated light is advanced clockwise through the sequential order once each second.

### CROSS-REFERENCE TO RELATED APPLICATIONS

This Application claims the benefit of U.S. Provisional Application 62/100,239 filed on Jan. 6, 2015, the contents of which is incorporated in its entirety.

### FIELD OF THE INVENTION

The present invention relates to apparatuses for displaying information.

### BACKGROUND OF THE INVENTION

Picture frames have heretofore been combined with clocks so as to combine the ability to tell time simultaneously with the ability to admire a photograph. The information that can be displayed is typically limited to time information.

### SUMMARY OF THE INVENTION

Forming one aspect of the invention is an apparatus for use with a picture supported therein. The apparatus includes a subassembly having each of a body exhibiting a mount for releasably supporting the picture, a computing functionality (e.g. a computer processor, microprocessor or the like), a plurality of (such as sixty) lights arranged to surround the mount portion of the body, the lights being arranged according to any of a perimeter extending and/or sequential order.

In operation, each of the lights (such as individual LED elements) is actuated to issue an illuminating output upon receipt of an electric signal thereto, touch-sensitive buttons further being configured into the subassembly for receipt of a desired keyed input in order to actuate the lights according to a desired output Mode of operation or protocol. Each of the lights, touch-sensitive buttons, and computing functionality are directly or indirectly electrically coupled to each other.

The computing functionality (i.e. processor) is adapted to direct operation of the lights in accordance with the Mode of light operation selected in dependence on the desired input received from the touch-sensitive buttons. One mode of light operation is a single light mode in which each of the (typically sixty) lights is sequentially actuated for a period of one second so that the position of the actuated light is advanced clockwise through the sequential order once each second.

Further aspects of the invention will become apparent from the following description taken together with the accompanying drawings, the latter being briefly described hereinafter.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is front view of the information display apparatus according to one embodiment of the invention within which is mounted a picture;

FIG. 2 is an alternate front view of the apparatus shown in FIG. 1; and

FIG. 3 is a front view of a subassembly of the apparatus shown in FIG. 1.

### DETAILED DESCRIPTION OF THE PREFERRED EMBODIMENTS

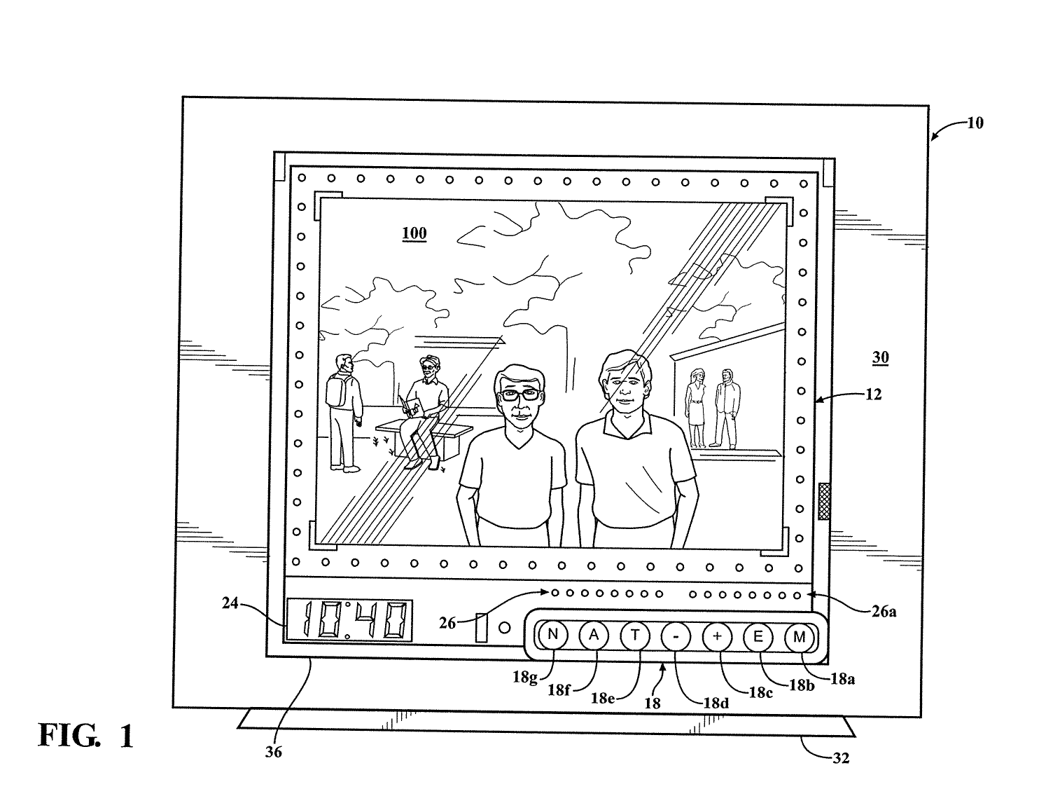

Referring to FIGS. 1 to 3, an apparatus for use with a picture is generally shown at 10 in accordance with one non-limiting embodiment of the present inventions. As will be described in further detail, the information display apparatus is capable of being utilized in combination with a picture frame holder, with it further being understood that the inventions are capable of alternative applications not requiring a picture frame consistent with the description and claims.

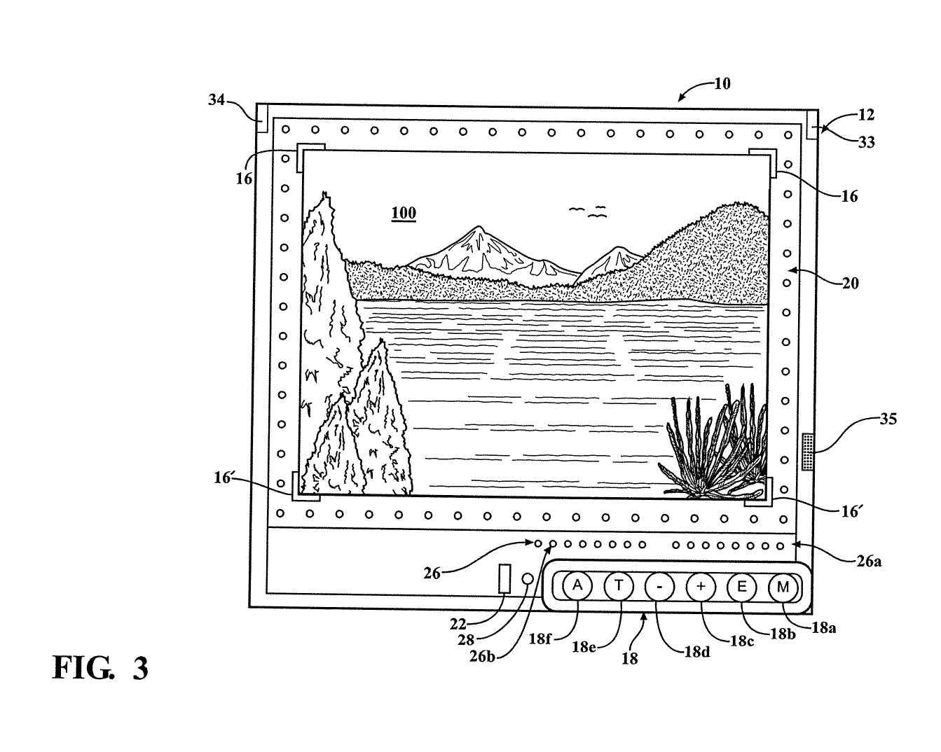

The apparatus includes a subassembly 12. The subassembly includes a body (such as identified and shown in non-limiting fashion in FIG. 3 as a rectangular extending outer frame 14) that has a mount for releasably supporting a picture 100. The mount, as further illustrated in one non-limiting application, can be provided as a plurality of protruding picture support locations (see upper linear support locations 16 along with lower “L” or bracket shaped locations 16′) which arranged about the subassembly and corresponding to perimeter edge supporting locations for the associated picture 100.

Without limitation, the supporting locations 16/16′ providing the picture mount can also include any other structure for mounting a picture, such as clips, deformable tabs, or the like. It is also envisioned that the mounting structure can be reconfigured or otherwise dimensioned to accommodate pictures of varying shapes and sizes. In the exemplary embodiment, the mount is dimensioned to support a picture that is 6 inches by 4 inches. Further, while the exemplary embodiment shows a body with a rectangular configuration, it will be appreciated that the body may be configured in other shapes.

The subassembly further includes a plurality of touch-sensitive input buttons, see as shown in non-limiting fashion at 18 and such as which are arranged along a lower edge of the subassembly body. Also shown are a plurality of lighting elements (lights) 20 (such as sixty) which are integrated into the subassembly 12 and which are arranged so as to surround the picture support locations 16/16′ (again picture mount), along with the incorporation of a computing functionality 22, this again identifying any of a computer processor, microcontroller, a remote computer communicatively coupled to the apparatus, or the like.

The lights are typically small, and will in most cases be provided as light emitting diodes (LEDs), although other types of lights capable of production in relatively small or miniature form are within the scope of the present disclosure. Each light is actuated to emit light upon receipt of an electric signal thereto. The use of sixty lights is intended in an embodiment to correspond to the sixty seconds in a minute and, as is further shown, are arranged around the subassembly outward of the picture support locations 16/16′ (or mount) in a sequential order.

In an exemplary (and non-limiting) embodiment, the lighting elements 20 form a loop around the mount so that the first and last of the sixty lights are located adjacent one another. The shape formed by the lights may be dependent on the shape defined by the mount (e.g. picture supporting and perimeter defined locations 16/16′). For example, in the embodiment shown in the figures, the mount follows a generally rectangular profile, and the lights are accordingly arranged in a rectangular fashion around the mount. However, it is not necessary that the lights surround the mount in the same shape defined by the mount, or that the lights form a loop around the mount, it being understood that the spacing, configuration and layout of the lighting elements 20 along with the other features of the assembly can be modified without departing from the inventive scope thereof as defined by the appended claims.

The lights, buttons, and computing functionality are electrically coupled to each other either directly or indirectly. The body of the subassembly in the exemplary embodiment integrates a circuit board which, as is known in the art, incorporates electrically conductive interconnections on a non-conductive substrate, so that the interconnections allow for electrical coupling between components attached thereto. Power is supplied to the subassembly from an external power source (e.g., by one or more batteries, or by wired connection to a standard 120 volt electrical receptacle which are not shown however the construction of which is well understood in the relevant art).

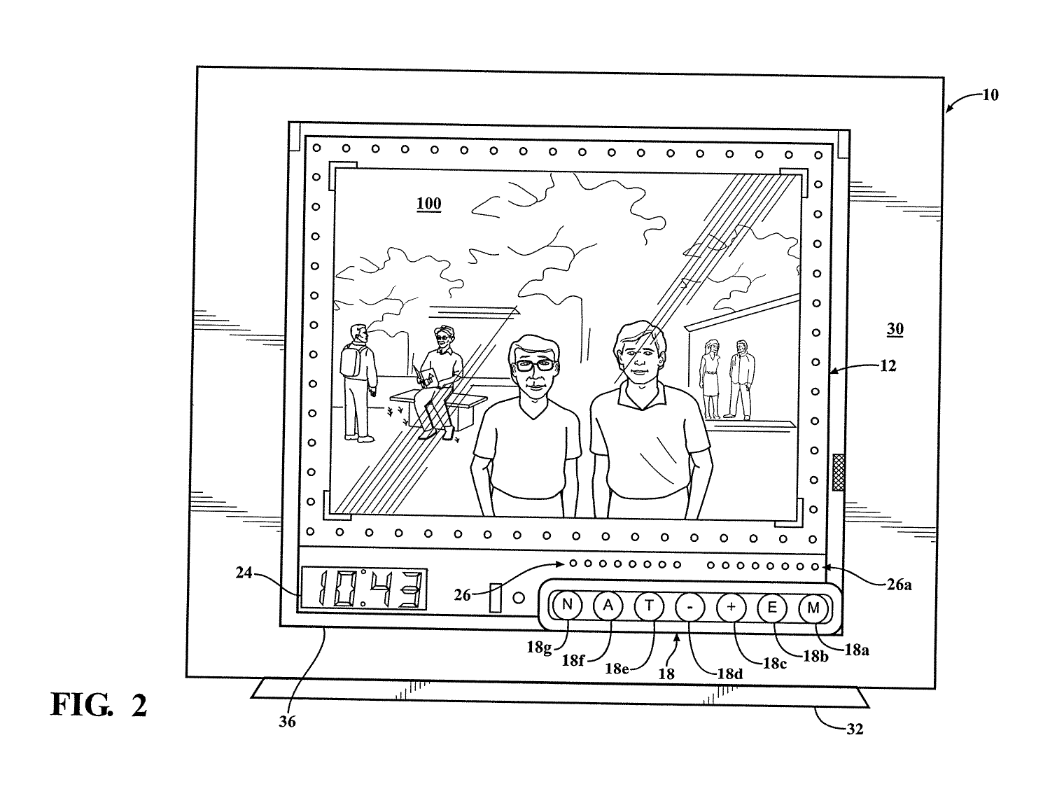

In the exemplary embodiment, the subassembly has at least six touch-sensitive buttons, denoted in FIG. 3 as “M” (18a), “E” (18b), “+” (18c), “−” (18d), “T” (18e), and “A” (18f), denoting “Mode”, “Edit Mode”, “Increment”, “Decrement”, “Time Mode”, and “Alarm Clock Mode”, respectively. Additional buttons may be utilized, such as the “N” button (at 18g) shown in FIGS. 1 and 2, to allow for the provision of further functionality. Each of the buttons may be labelled in a manner other than that shown in the figures, or may be unlabeled.

The subassembly is capable of being electrically coupled to a digital display 24, shown in FIGS. 1 and 2. The apparatus comprises both the subassembly 12 and the digital display 24 when the digital display is coupled to (i.e. integrated or otherwise secured are incorporated into) the subassembly 12, and typically the digital display is directly electrically coupled to the computing functionality/processor. In the exemplary and non-limiting embodiment, the digital display is a four-integer display comprised of four seven-segment displays (SSDs), each SSD including a decimal point, although other types of digital displays, such as dot matrix displays, LED displays, and so on, may be used.

While the exemplary embodiment shows the buttons and digital display below the picture mount at the bottom of the subassembly, alternative configurations are possible. For example, the buttons and digital display may be reversed so that the buttons are at the bottom left of the subassembly, and the digital display at the bottom right. Alternatively, the buttons and/or the digital display may be located at the top of the subassembly, above the mounted picture, or to one or both sides of the mounted picture such that they are vertically arranged in use.

The subassembly further includes a plurality of status display lights 26, see as best shown in FIG. 3. The status display lights are shown above the touch-sensitive buttons 18a-18f in the figures, although they may be alternatively arranged or disposed on the subassembly. As with the (sixty) lighting elements 20, the status display lights 26 are typically small and may be LEDs or some other suitable type of light. In the exemplary embodiment, up to sixteen status display lights are linearly arranged such that they are horizontally displayed above the buttons 18 in use.

The subassembly 12 also includes a reset switch 28 (FIG. 3) that, when activated, interfaces with the computing functionality/processer to cause it to reset the apparatus to default operating values. In the embodiment shown in the figures, the reset button or switch is located adjacent the digital display when the digital display is coupled to the subassembly to form part of the apparatus. To avoid the accidental activation of the reset switch, it is accessible through a small hole formed in the body 14, so that its activation requires the use of a small instrument, such as a pin, inserted into the hole or recess.

The apparatus may further include a frame 30 (see also FIGS. 1-2) that is releasably securable to the subassembly, such as without limitation by screws, clips, tabs, or the like, and which in use provides a clean outward appearance to the apparatus. When the frame 30 is releasably secured to the subassembly 12, the buttons 18a-18g, digital display 24, status display lights 26, (sixty) perimeter extending lights 20, and picture mount (picture supporting locations 16/16′) are surrounded by the frame 14 such that they are viewable, as shown in FIGS. 1 and 2. The apparatus may also include a stand 32 for supporting the apparatus upright in use.

The apparatus may further include a transparent cover (not shown) that in use is disposed between the frame 30 and the outer frame or body 14 of the subassembly so that when the frame is releasably secured to the subassembly, the transparent cover overlies a picture supported by the mount. The apparatus further includes a receiver 33 (FIG. 3) for receiving information over radio signals, a digital thermometer 34, and a speaker 35, each of these being provided according to a known construction and integrated into the subassembly in a manner such that each is electrically coupled to the processor or computing functionality 22.

In use, picture 100 is inserted between the mount or support locations 16/16′ so that the picture is supported within the sixty lights surrounding the mount. The digital display 24 is secured to the subassembly 12 such that it is in electrical communication with the computing functionality 22, and power is supplied to the apparatus 10. The apparatus may be supported upright by stand 32, and a transparent cover may overlie the picture such that it is secured in place between the releasably secured frame 30 and the subassembly body 14.

The computing functionality 22 (again processor or microprocessor) is configured to provide direct operation of the plurality (e.g. sixty) of lighting elements 20 in accordance with the mode of light operation that is selected based on input received from the touch-sensitive buttons (18a-18g). As previously described, there are four modes of light operation in the exemplary embodiment: a single light mode, an intermittent single light mode, a cumulative light mode, and an intermittent cumulative light mode. The computing functionality 22 may be configured to provide more or less light operation modes of different types.

In the single light mode, each of the lighting elements 20 is sequentially actuated for a period of one second so that the position of the actuated light is advanced clockwise through the sequential order of the lights once each second (totaling one minute for sixty such arranged lighting elements). In the intermittent single light mode, every fifth light of the sixty lights 20 is sequentially actuated, every five seconds, to emit light for a period of one second so that the position of the actuated light is advanced clockwise through the sequential order of the lights once every five seconds. Alternatively, the intermittent single light mode may be configured as described with the exception that every fifth light of the sixty lights is sequentially actuated to emit light for a period of five seconds.

In the cumulative light mode, shown in FIGS. 1 and 2, each of the sixty lights 20 is sequentially actuated, each second, in a clockwise direction. Each of the sixty lights, once actuated, remains actuated until the sixtieth light has been actuated for a period of one second. In the intermittent cumulative light mode, each mutually exclusive and adjacent group of five adjacent lights of the sixty lights 20 is sequentially actuated, every five seconds, in a clockwise direction such that each of the sixty lights, once actuated, remains actuated until the last of the sixty lights has been actuated for a period of five seconds.

The computing functionality 22 is further adapted to configure the digital display 24 in a display mode 36. The display mode is selected depending on input received from the touch-sensitive buttons 18. Repeated actuation of the “M” or “Mode” touch-sensitive button cycles the digital display through the display modes to select a selected display mode 36, shown in FIGS. 1 and 2 as the time mode, which is described in further detail below. The information that is displayed on the digital display is dependent upon the selected display mode.

In the exemplary embodiment, there are eight display modes: a time mode, an alarm clock mode, a day of week and time zone mode, a month and day mode, a year mode, a timer mode, a temperature mode, and a stop watch mode.

In the time mode, the apparatus displays time information. The time information consists of a time of day that is comprised of hours, minutes and seconds. In the exemplary embodiment, in which the digital display includes four SSDs, two of the SSDs display the hours while the other two SSDs display the minutes. The number of seconds elapsed for each minute is indicated only by the sixty lights in accordance with the mode of light operation that is selected.

For example, FIGS. 1 and 2 show the apparatus with the sixty lights configured in the cumulative light mode, with FIG. 1 showing that five seconds have elapsed for the current minute, and FIG. 2 showing that eight seconds have elapsed for the current minute. The manner in which the mode of light operation is selected is described below. In embodiments where other types of digital displays are used, which are capable of also displaying the seconds elapsed for each minute, the seconds elapsed can be indicated by the sixty lights as well as by the digital display. The time information can be adjusted to any desired value using the touch-sensitive buttons in the manner described further below.

Further, when in the time mode, the time information can be synchronized, in a manner hereinafter described, with time synchronization information that is based on one or more atomic clocks and that is transmitted in a radio time signal on a frequency received by the receiver. The time synchronization is subject to transit delays based on the distance of the apparatus 10 from the radio time signal transmitter. In the exemplary embodiment, the apparatus will attempt to receive a radio time signal transmitted on a 60 kHz channel by the National Institute of Standards and Technology (NIST) WWVB time signal radio transmitter that is co-located with a set of atomic clocks at its location near Fort Collins, Colo., U.S.A.

In the alarm clock mode, the digital display displays alarm clock information consisting of a time at which an alarm will sound, which time can be adjusted to any desired value, in the manner described further below.

In the day of week and time zone mode, the digital display displays day of week and time zone information consisting of a day of the week and a time zone identifier representing a time zone. In the exemplary embodiment, the days of the week are represented by one of the four SSDs of the digital display 24 by an integer, as follows:

TABLE 1
Day of Week Identifiers

| | |
|---|---|
| Sunday | 1 |
| Monday | 2 |
| Tuesday | 3 |
| Wednesday | 4 |
| Thursday | 5 |
| Friday | 6 |
| Saturday | 7 |

To the right of the day of the week, another of the four SSDs displays the time zone index, which is representative of a time zone in accordance with the following table:

TABLE 2
Time Zone Identifiers

| Time Zone | |
|---|---|
| Index | Time Zone |
| 1 | Atlantic Standard Time, Central South America, |
| | Dominican Republic, Eastern Canada, West Greenland, |
| | Bermuda |
| 2 | Eastern Standard Time, Western South America, Cuba, |
| | Bahamas, Haiti, Jamaica, East Central |
| 3 | Central Standard Time, Mexico, Easter Island, Galapagos |
| | Islands, Central Canada, Central America |
| 4 | Mountain Standard Time, West Central Canada, South |
| | Baja Peninsula, Central and Western Mexico |
| 5 | Pacific Standard Time, Western Canada, North Baja |
| | Peninsula |
| 6 | Alaska Standard Time, Gambier Islands (French |
| | Polynesia) |
| 7 | Hawaii-Aleutian Standard Time, Central French |
| | Polynesia, Tokelau, Cook Islands, Tahiti, Johnston Atoll |

It will be appreciated that the days of the week and/or the time zones may be configured by the computing functionality to be referenced in a manner other than that shown in Tables 1 and 2. Further, while the day and time zone identifier are represented by integers in the exemplary embodiment, they may alternatively be displayed, such as by known character abbreviations (e.g., “MON”, “EST”) where the digital display permits. The time zone can be manually adjusted in the manner described below, and should be set by the user to match the user's local time zone. The computing functionality is adapted to account for the local time zone in order to set the appropriate local time when time synchronization information is received from a radio time signal transmitter. In the exemplary embodiment, the day of the week cannot be modified and is calculated by the computing functionality based on the current calendar date, although in other embodiments it may be possible to manually adjust the day of the week in the day and time zone mode.

In the exemplary embodiment, in the month and day mode the left two SDDs of the digital display 24 display an integer representation of the current month (1 to 12 representing January to December, respectively) and the right two SSDs display the calendar date for the current month (with possible values ranging from 1 to 31). In the year mode, the digital display displays the current year. When in the month and day mode, or in the year mode, the month and day values, or the year value, can be manually adjusted in the manner described below. Further, depending on the type of the digital display used, in other embodiments, the month may be displayed in character form, such as by a known abbreviation (e.g., “JAN” for January).

In the timer mode, the digital display displays an amount of time remaining relative to a preset timer value. The timer value is manually set in the manner hereinafter described. Once the timer value is set, the user will start the timer using the touch-sensitive buttons (in the manner described below) and the computing functionality will decrement the time until no time remains (so that, in the exemplary embodiment, the digital display displays “00:00” and the seconds are reset to zero so that none of the sixty lights 20 emit light). Further, and also described in greater detail below, the user can use the buttons to stop the timer and clear the timer (again, so that in the exemplary embodiment the digital display displays “00:00” and the seconds are reset to zero so that none of the sixty lights 20 emit light). The computing functionality 22 is adapted such that once the timer value is fully decremented, the computing functionality sends an electric signal to the speaker 35 to cause the speaker to sound an alarm sound indicating that the preset time has elapsed. The alarm sound may comprise a one-time limited duration sound, or a repeating or constant sound requiring activation of a button to stop the sound.

In the temperature mode the digital display displays an ambient temperature recorded by the digital thermometer 34 and communicated thereby to the computing functionality 22. While the temperature cannot be modified, a user can toggle between Celsius and Fahrenheit as the unit in which the temperature is displayed. The manner in which the temperature units are toggled is described below.

In the stop watch mode, the digital display displays an amount of time elapsed since actuation of a stop watch start function. Using the touch-sensitive buttons, a user can start, stop, and restart the digital stop watch, as well as clear the value shown on the digital display (so that in the exemplary embodiment the digital display displays “00:00” and the seconds are reset to zero so that none of the sixty lights 20 emit light) should the user wish to begin timing a new event. The manner in which these actions are carried out is described in detail below.

It will be appreciated that more or less modes, each configured to display different information from that described, may be configured.

In the exemplary embodiment, the sixteen status display lights (SDLs) 26 include eight right-most SDLs 26a and eight left-most SDLs 26b (see as further shown in FIG. 3). Actuation of any one of the right-most SDLs depends on the selected display mode so that which of the eight right-most SDLs is actuated uniquely identifies a respective one of the eight display modes as being the currently selected display mode. A user can cycle through the display modes using the “Mode” button as hereinbefore described, or alternatively, a user can switch to the time or alarm clock modes using the “A” or “T” buttons, respectively, as described hereinafter in further detail. Which of the eight right-most SDLs is actuated depends on which is the selected display mode (e.g., the time mode may be indicated by the right-most status display light, the alarm clock mode by the status display light adjacent to the right-most light, and so on).

The eight left-most SDLs 26b indicate operating conditions, and in the exemplary embodiment, the eight left-most SDLs indicate the following specific information (with light no. 9 indicating the ninth light in from the right of the subassembly, and so on):

TABLE 3
Left-Most Status Display Light Indicators

| Light | Actuation of the SDL | Default Value |
|---|---|---|
| No. | indicates . . . | (when the SDL is off) |
| 9 | Alarm clock is enabled | Alarm clock is disabled |
| 10 | Time information is | Time information |
| | displayed in a 24-hour format | displayed in a 12-hour format |
| 11 | Successful time | No successful time |
| | synchronization within the past 24 | synchronization within the |
| | hours | past 24 hours |
| 12 | Daylight savings is | Daylight savings is not |
| | activated | activated or not applicable in |
| | | the selected time zone |
| 13 | Not yet defined | Not yet defined |
| 14 | Not yet defined | Not yet defined |
| 15 | Not yet defined | Not yet defined |
| 16 | Not yet defined | Not yet defined |

It will be appreciated that more or less of the right-most or left-most SDLs may be used. The number of right-most SDLs will generally correspond to the maximum number of display modes to which the digital display 24 can be configured by the computing functionality 22, although fewer right-most SDLs may be provisioned than the number of display modes (in which case some display modes will not have an associated status display light). It will further be appreciated that while in the exemplary embodiment there are eight left-most SDLs, there need only be four. The remaining four, which are undefined, may be omitted from the design, or kept in the design for potential configuration by the computing functionality to indicate some other operating conditions.

The computing functionality is further configured such that actuation of the time mode button when in a display mode other than the time mode causes actuation of the time mode. Similarly, actuation of the alarm clock mode button when in a display mode other than the alarm clock mode causes actuation of the alarm clock mode. In either case, if the digital display is already configured in the time mode or the alarm clock mode when the “T” or “A” button, respectively, is actuated, no change will take place. In this manner, the time and alarm clock modes, generally expected to be the most commonly used of the display modes, can be quickly accessed by touching their respective buttons, rather than by toggling through the various modes using the “M” or “Mode” button.

Further, the time, alarm clock, day of week and time zone, month and day, year, and timer modes each have associated editable fields. Each actuation of the “E” or “Edit Mode” button when in any of those modes causes each of the editable fields for the selected display mode to become editable in turn (which of the editable fields is editable could be indicated, for example, by the blinking of that field, a change in its colour, etc.). Once an editable field becomes editable, the value displayed by that editable field in the digital display is incremented by actuation of the increment button or decremented by actuation of the decrement button.

A user can exit the edit mode by selecting the “E” button once more after using it to cycle through all of the editable fields for the selected display mode, or by selecting the “M” or “Mode” button. For example, if the time is to be changed, the user would select the “Time Mode” button, or the “Mode” button repeatedly until the time mode is the selected mode. Thereafter, the user would touch the “Edit Mode” button, causing the hours field to become editable as indicated, for example, by the blinking of that editable field. The user can then adjust the hours using the increment or decrement buttons, and touch the “Edit Mode” button again to confirm the change to the hours and to make the minutes field editable (as indicated by its blinking, for example). Again, the user can change the minutes displayed with the “+” or “−” buttons, and touch the “E” button again. In the case of the time mode, in one embodiment, touching the “E” button at that point can exit the edit mode, or, in an alternate embodiment, allow the user to edit the number of seconds using the “+” or “−” buttons to correspondingly move the currently or forward-most actuated light in the sixty lights 20 surrounding the picture mount locations 16/16′. In the latter case, touching the “E” button again after the number of seconds has become editable would exit the edit mode (as the user will have cycled through all of the editable fields for the time mode), and a further touch of the “E” button thereafter would cause the edit mode to be re-entered for the time mode.

Table 4, below, depicts the behaviour evoked by each of the “M”, “E”, “+”, and “−” buttons when in an Edit Mode, depending on the currently selected display mode which is shown in the left column (Nb. the Edit Mode cannot be entered when in the Temperature Mode or in the Stop Watch Mode):

TABLE 4
Functions in Edit Mode

| | “M” | “E” | “+” | “−” |
|---|---|---|---|---|
| Time | Exit “Edit | Change to next editable | Increment | Decrement |
| | Mode” | field or exit Edit Mode if already at | value of | value of editable field |
| | | the last editable field | editable field that | that is editable |
| | | | is editable | |
| Alarm | Exit “Edit | Change to next editable | Increment | Decrement |
| Clock | Mode” | field or exit Edit Mode if already at | value of | value of editable field |
| | | the last editable field | editable field that | that is editable |
| | | | is editable | |
| Day Of | Exit “Edit | Change to next editable | Increment | Decrement |
| Week & | Mode” | field or exit Edit Mode if already at | value of | value of editable field |
| Time | | the last editable field | editable field that | that is editable |
| Zone | | | is editable | |
| Month & | Exit “Edit | Change to next editable | Increment | Decrement |
| Day | Mode” | field or exit Edit Mode if already at | value of | value of editable field |
| | | the last editable field | editable field that | that is editable |
| | | | is editable | |
| Year | Exit “Edit | Change to next editable | Increment | Decrement |
| | Mode” | field or exit Edit Mode if already at | value of | value of editable field |
| | | the last editable field | editable field that | that is editable |
| | | | is editable | |
| Temperature* | Switch to | No Action | No | No Action |
| *Edit | “Timer” | | Action | |
| Mode cannot be | mode | | | |
| entered when in | | | | |
| Temperature Mode | | | | |
| Timer | Exit “Edit | Change to next editable | Increment | Decrement |
| | Mode” | field or exit Edit Mode if already at | value of | value of editable field |
| | | the last editable field | editable field that | that is editable |
| | | | is editable | |
| Stop | Switch to | No Action | No | No Action |
| Watch* | “Time” | | Action | |
| *Edit | mode | | | |
| Mode cannot be | | | | |
| entered when in Stop | | | | |
| Watch Mode | | | | |

When not in an Edit Mode, the “increment” or “decrement” touch-sensitive buttons may perform certain mode-related actions, depending on the selected mode. For example, in the exemplary embodiment, the “increment” and “decrement” buttons do not have associated mode-related actions for the month and day mode or for the year mode. The mode-related actions triggered by activation of either the “+” or “−” buttons for the remaining modes is specified in Table 5, below, in which the top row indicates the button that is activated and the left column indicates the currently selected mode:

TABLE 5
Increment/Decrement Functions when not in Edit Mode, etc.

| | “M” | “E” | “+” | “−” |
|---|---|---|---|---|
| Time | Switch to | Enter | Synchronize | Cycle to the |
| | “Alarm | “Edit | the time information | next mode of light |
| | Clock” mode | Mode” | | operation |
| Alarm Clock | Switch to | Enter | Turn alarm | Turn alarm |
| | “Day of | “Edit | clock on/off | clock on/off |
| | Week & Time Zone” | Mode” | | |
| | mode | | | |
| Day Of Week & | Switch to | Enter | Toggle time | Enable/disable |
| Time Zone | “Month & | “Edit | information between 12- | Daylight Savings |
| | Day” mode | Mode” | hour and 24-hour format | |
| Month & | Switch to | Enter | No Action | No Action |
| Day | “Year” mode | “Edit | | |
| | | Mode” | | |
| Year | Switch to | Enter | No Action | No Action |
| | “Temperature” mode | “Edit | | |
| | | Mode” | | |
| Temperature | Switch to | No | Toggle | Toggle |
| | “Timer” | Action | temperature units | temperature units between |
| | mode | | between Celcius and | Celcius and Fahrenheit |
| | | | Fahrenheit | |
| Timer | Switch to | Enter | Clear Timer | Start timer if |
| | “Stop | “Edit | | stopped, or stop timer if |
| | Watch” mode | Mode” | | already started |
| Stop Watch | Switch to | No | Clear | Start stop watch |
| | “Time” | Action | Stop Watch | if stopped, or stop it if |
| | mode | | | already started |

Table 5 also shows the result of actuating the “E” button when in different display modes, and further, depicts the order in which the various display modes are traversed in the exemplary embodiment when cycling through the display modes using the “M” button. It will be appreciated that the computing functionality 22 may be configured to cycle through the display modes in an alternate order.

Aside from manual invocation of time synchronization, the computing functionality 22 of the exemplary embodiment of the apparatus 10 is configured to attempt time information synchronization with the radio time signal just after midnight each day. Five attempts to successfully receive the radio time signal are made before the operation is abandoned. Various factors can contribute to a failed time signal receive operation: the distance between the apparatus and the radio time signal transmitter; local signal or electromagnetic noise; the time of day (signal strength is known to be at its strongest in the hours just after midnight); etc. The digital display, status display lights, and the sixty lights are all deactivated (with the exception of light no. 11 (see Table 3) which provides an indication of whether there has been a successful time synchronization within the past 24 hours) during the daily automated time synchronization operation to eliminate the noise that would otherwise be caused by the display refresh signals.

The receiver 33 can also be electrically coupled to the computing functionality 22, a further mode-related action when the increment button 18c is actuated when in the time mode 18e synchronizing the time information with time synchronization information that is based on one or more atomic clocks (not shown), and that is transmitted in a radio time signal by a time signal radio transmitter on a frequency received by the receiver.

It is to be understood that what has been described are exemplary embodiments of the invention and further variations are possible. Without limitation in this regard, it should be understood that the microcontroller in the device can be programmed in a myriad of possible ways. Similarly, the touch button sequence can be modified to a subset of the functionality of the device; additionally, further functionality can be overlayed.

Having described my invention, other and additional preferred embodiments will become apparent to those skilled in the art to which it pertains, and without deviating from the scope of the appended claims. To this end, additional variants contemplate other subassemblies not limited to a combination clock and picture frame/body, such potentially including being integrated into lamps, radios, other table-top articles and the like.

I claim:

1. An apparatus for use with a picture supported therein, said apparatus comprising:
a subassembly including:
a body having a mount adapted for releasably supporting the picture,
a computing functionality integrated into said body,
a plurality of sixty lighting elements arranged to surround said mount in a sequential order, each of said lights actuable upon receipt of an electric signal thereto and emitting light upon actuation thereof, and
touch-sensitive buttons for receipt of an input:
each of said lighting elements, said touch-sensitive buttons, and said computing functionality being directly or indirectly electrically coupled to each other, and
said computing functionality directing operation of said lights in accordance with a mode of light operation selected in dependence on input received from said touch-sensitive buttons,
wherein one of said modes of light operation further including a single light mode in which each of said sixty lights is sequentially actuated for a period of one second so that the position of the actuated light is advanced clockwise through said sequential order once each second.

2. The apparatus of claim 1, further comprising said computing functionality directing operation of said lighting elements in accordance with an intermittent single light mode selected in dependence on said input received from said touch-sensitive buttons, wherein in said intermittent single light mode every fifth of said sixty lighting elements is sequentially actuated, every five seconds, to emit light for a period of one second so that the position of said actuated lighting element is advanced clockwise through said sequential order once every five seconds.

3. The apparatus of claim 1, further comprising said computing functionality directing operation of said lighting elements in accordance with a cumulative light mode selected in dependence on said input received from said touch-sensitive buttons, wherein in said cumulative light mode each of said sixty lights is sequentially actuated, each second, in a clockwise direction such that each of said sixty lighting elements, once actuated, remains actuated until a sixtieth of said sixty lighting elements has been actuated for a period of one second.

4. The apparatus of claim 1, further comprising said computing functionality directing operation of said lighting elements in accordance with an intermittent cumulative light mode selected in dependence on said input received from said touch-sensitive buttons, wherein in said intermittent cumulative light mode each mutually exclusive and adjacent group of five adjacent lighting elements of said sixty lights is sequentially actuated, every five seconds, in a clockwise direction such that each of said sixty lighting elements, once actuated, remains actuated until a sixtieth of said sixty lighting elements has been actuated for a period of five seconds.

5. The apparatus of claim 1, further comprising a digital display electrically coupled to said computing functionality, said computing functionality further configuring said digital display in a display mode in dependence on input received from said touch-sensitive buttons, said touch-sensitive buttons including a mode button, repeated actuation of which cycles said digital display through said display modes to select a selected display mode, wherein information that is displayed on said digital display depends on said selected display mode.

6. The apparatus of claim 5, one of said display modes further comprising a time mode in which said apparatus displays time information of hours, minutes and seconds, said digital display displaying said hours and said minutes, and the seconds elapsed for each of said minutes indicated by said sixty lighting elements in accordance with said mode of light operation.

7. The apparatus of claim 6, another of said display modes further comprising an alarm clock mode in which said digital display displays alarm clock information of a time at which an alarm will sound.

8. The apparatus of claim 7, another said display modes further comprising a day of week and time zone mode in which said digital display provides a day of week and time zone information for the day of the week, and a time zone identifier representing a time zone.

9. The apparatus of claim 8, another of said display modes further comprising a month and day mode in which said digital display displays month and date information relating to the month and day of the month.

10. The apparatus of claim 9, another of said display modes further comprising a year mode in which said digital display displays a year.

11. The apparatus of claim 10, another said display modes further comprising a timer mode in which said digital display displays an amount of time remaining relative to a preset timer value.

12. The apparatus of claim 11, another of said display modes further comprising a temperature mode in which said digital display displays an ambient temperature.

13. The apparatus of claim 12, another of said display modes further comprising a stop watch mode in which said digital display displays an amount of time elapsed since actuation of a stop watch start function.

14. The apparatus of claim 5, said subassembly further comprising a plurality of status display lights, actuation of any one of said status display lights being dependent on the selected display mode so that an actuated one of said status display lights uniquely identifies a respective one of said display modes as the selected display mode.

15. The apparatus of claim 6, one of said touch-sensitive buttons further comprising a time button, said computing functionality actuating the time button when in a display mode.

16. The apparatus of claim 7, one of said touch-sensitive buttons further comprising an alarm button, said computing functionality actuating the alarm button when in a display mode.

17. The apparatus of claim 11, each of said time mode, alarm mode, day of week and time zone mode, month and day mode, year mode, and timer mode further comprising associated editable fields, said touch-sensitive buttons including an edit mode button, an increment button, and a decrement button, each actuation of said edit mode button causing each of said editable fields for said selected display mode to become editable in turn such that a value displayed by the editable field that is editable is incremented by actuation of the increment button or decremented by actuation of the decrement button.

18. The apparatus of claim 13, said touch-sensitive buttons further comprising an increment button and a decrement button, actuation of said increment button or said decrement button when in the time mode, alarm mode, day of week and time zone mode, temperature mode, timer mode, or stop watch mode triggering a mode-related action for the selected display mode.

19. The apparatus of claim 18, further comprising a receiver electrically coupled to said computing functionality, a further mode-related action when the increment button is actuated when in the time mode synchronizing the time information with time synchronization information that is based on one or more atomic clocks, and that is transmitted in a radio time signal by a time signal radio transmitter on a frequency received by said receiver.

20. A display apparatus comprising:
a subassembly including:
a body;
a computing functionality integrated into said body,
a plurality of lighting elements integrated into said body and arranged to surround said mount in a sequential order, each of said lighting elements actuable upon receipt of an electric signal thereto and emitting light upon actuation thereof, and
a plurality of touch-sensitive buttons arranged upon a surface of said body, an input received from said buttons communicating to said lighting elements via said computing functionality;
said computing functionality directing operation of said lights in accordance with a mode of light operation selected in dependence on input received from said touch-sensitive buttons.
